(19) United States
(12) Patent Application Publication
(10) Pub. No.: US 2001/0034963 A1
(43) Pub. Date: Nov. 1, 2001

(54) Method and system for gas based extermination of rodentia

(75) Inventor: Allen C. Jones, Ocala, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: BIO-TRAX, INC., Ocala, FL (US)

(21) Appl. No.: 09/808,773

(22) Filed: Mar. 15, 2001

Related U.S. Application Data
(60) Provisional application No. 60/189,745, filed on Mar. 16, 2000.

(51) Int. Cl. A01M 1/00

(52) U.S. Cl. 43/124

(57) ABSTRACT

A method and system exterminates rodents in an at least partial enclosure by changing a carbon dioxide gas concentration of an ambient atmosphere in the at least partial enclosure. The gas based method is particularly effective in exterminating rodents in transport trailers, truck cargo holds, buildings, ship cargo holds, sewer lines, and tunnels or subways.

### CROSS-REFERENCE TO RELATED APPLICATIONS

This application is based upon and claims priority from prior U.S. patent application Ser. No. 60/189,745, filed on Mar. 16, 2000, the entire disclosure of which is herein incorporated by reference.

### BACKGROUND OF THE INVENTION

1. Field of the Invention

This invention relates in general to methods for exterminating rodents, and more particularly to a method for gas based extermination of rodentia.

2. Description of the Prior Art

Operators of many types of commercial facilities and transports have come to recognize that there is a serious problem with rats and mice. For example, in warehouses, many of these critters come out at night from their nests, such as from underneath the gondolas (storage racks), to retrieve the water left on concrete floors by cleaning crews and equipment.

Conventional systems for keeping commercial operations free of Rodents have been less than successful for a number of reasons. First, the conventional systems were not able to keep the doors closed continually. Secondly, the rodents have been becoming resistant to the poisons that the FDA and USDA have authorized. Thirdly, rodents seem to be smart enough to start avoiding the traps and sticky paper being used. Fourth, a majority of new rodent arrivals typically come into an environment, such as a warehouse or other commercial operations, off “The Loads” from the tractor trailers delivering various commodities.

The physiological reaction of rodents to many common poisons results in loss of body fluids such as blood and urine during the act of death. This results in soilage and contamination of food and food containers and significant economic loss. Rodentia learn about or adapt to the presence of these poisons in their environment and the survivors become harder to eliminate with each succeeding generation

Additionally, this particular type of distribution organization has experienced a number of visits and citations from governmental authorities. It appears that the industry as a whole, is losing ground to various rodent populations. The FDA and USDA are currently having greater difficulty in instituting and administering sanitation programs within these establishments. The staff of government inspectors is somewhat limited while the number of large facilities continues to grow. The number of citations seems to be rising as well.

As the population of North America continues to grow, the need for more food distribution will grow likewise. As food requirements continue to rise and the amount of food in the pipeline continues to grow, so will the colonies of rodents. More food, additional and larger warehouses, and fewer inspectors are a sure recipe for larger and more prolific rodent colonies. Examples throughout the world clearly show that when the availability of food and nesting material increases, so does the number of “Rodentia.”

Diseases borne by rodentia such as the feared and deadly “Hanta” virus are of increasing concern. In addition, there is increasing understanding of the role rodents play in transmitting pathogenic bacteria by contaminating our food supply. Therefore a direct correlation is emerging between our ability to detect and monitor viruses and bacteria and the concern that the population at large is at significant risk from sharing accommodations and food supply with the rodent world.

Therefore, there is a need for a more effective process for controlling and eliminating “Rodentia”, and which preferably includes keeping the food supply free from traditional chemicals, insecticides, and poisons that are currently being used to control the rodent populations. Accordingly, there exists a need for overcoming the disadvantages of the prior art as discussed above.

### SUMMARY OF THE INVENTION

According to a preferred embodiment of the present invention, a method is used for exterminating at least one rodent in an at least partial enclosure. The method comprises the steps of introducing gas comprising carbon dioxide gas into an at least partial enclosure at least partially containing an ambient atmosphere; and changing, by introducing the gas, the concentration of carbon dioxide in the ambient atmosphere sufficient to exterminate at least one rodent that respirates the ambient atmosphere.

Thereafter, the method preferably restores the ambient atmosphere to substantially an air atmosphere that is safe for human respiration.

According to a preferred embodiment of the present invention, a gas based rodentia extermination system comprises a controllable gas port for mechanically coupling to an at least partial enclosure at least partially containing an ambient atmosphere for selectively communicating gas with the ambient atmosphere; a gas line mechanically coupled to controllable gas port for providing gas communication with the ambient atmosphere; and a gas container containing a gas comprising a concentration of carbon dioxide, the gas container being mechanically coupled to the gas line and to the controllable gas port, for selectively providing the gas to the at least partial enclosure to change a concentration of carbon dioxide in the ambient atmosphere sufficient to exterminate at least one rodent that respirates the ambient atmosphere.

### BRIEF DESCRIPTION OF THE DRAWINGS

A clearer understanding of the present invention will be gained on studying the detailed description of preferred embodiments given by way of non-limiting examples and illustrated by the appended drawings, in which:

FIG. 1 is a block diagram illustrating a first exemplary system, in accordance with a preferred embodiment of the present invention.

FIG. 2 is a block diagram illustrating a second exemplary system, in accordance with a preferred embodiment of the present invention.

FIG. 3 is a block diagram illustrating a third exemplary system, in accordance with a preferred embodiment of the present invention.

### DESCRIPTION OF THE PREFERRED EMBODIMENTS

This invention utilizes new methods and processes for a rodentia extermination system to effectively control and eliminate “Rodentia”. A significant advantage of the present method and system is that extermination of rodentia is accomplished while keeping the food supply, dwellings, and workspaces free from traditional chemicals, insecticides and poisons that are currently being used to control the rodent populations.

The new processes, according to the present invention, not only address the problem of rodents already in a space or warehouse, but also address the serious problem of new rodents arriving, such as in tractor-trailers. In accordance with a preferred embodiment of the present invention, using CO2 to exterminate rodents, such as to asphyxiate all rodents where they may be found, is a sound process. CO2 is colorless, odorless, and tasteless. Laboratory tests clearly show that the rodents become disoriented when they respire CO2 and then they just go to sleep permanently. These treated areas are then properly evacuated of CO2, entered and dead rodents are removed. It is truly a kinder, simpler method of removing these pests. Additionally, the normal functions of the warehouse do not have to be interrupted. More importantly, the CO2 leaves no residue or creates any toxic problem for the food that it encounters. The new and novel process, according to the present invention, will provide a more effective process for an industry that sincerely needs one.

### Definitions

1. Air Line: Any flexible or rigid system of piping through which ambient air may be communicated into the Gas Sparger and through which a changed ambient atmosphere may be evacuated from a partial enclosure.

2. Ambient Air: The mixture of gases common to a specific locale and comprising nitrogen, oxygen, trace gases, water vapor, and various pollutants but sufficient to support life.

2A. Ambient Atmosphere: A mixture of gases common to a specific locale. For example, see definition of Ambient Air.

3. Aspirate: To compress, pump, or move gases with a motor and/or pressure driven device.

4. Asphyxiate: The act of suffocating a living organism by reducing the residual oxygen available to that organism, to the point that it expires due to oxygen starvation.

5. Carbon Dioxide Analyzer: An analytical instrument that can detect concentrations of carbon dioxide within an ambient air stream from part per million concentrations up to substantially 100% carbon dioxide.

6. Carbon Dioxide Generator: Any chemical reaction, mechanical, or electrical device which may be used to produce measurable amounts of carbon dioxide or to separate carbon dioxide from any gas source.

7. Controllable Gas Port: A valve that is mechanically and/or electrically controlled for stopping or starting the communication of gas through the Gas Line to the Gas Sparger.

8. Driving Out: The act of forcing a rodent or rodentia from a Partial Enclosure by creating undesirable conditions which alert the rodent to leave in advance of adverse conditions.

9. Evacuate (Evacuating): The act of removal of an Ambient Atmosphere from an enclosure or a partial enclosure by Aspiration.

10. Exterminate (Extermination): The act of killing within or forcing out rodentia from an enclosure or a Partial Enclosure.

11. Gas Container: Any container that may be used to hold or retain any gas in either a gaseous or liquid phase. The container may be portable or fixed and of any pressure rating. If the container is designed for liquid cryogenic storage, it will preferably include vaporization capability as an added feature.

12. Gas Line: Any rigid or flexible system of piping through which a pure or blended gas not substantially ambient air may be communicated from one location to another.

13. Gas Recycler: A collapsible container into which aspirated and/or evacuated ambient air which has undergone a changing of concentration of carbon dioxide may be temporarily stored until it can be aspirated into the next at least partial enclosure.

14. Gas Sparger: A device by which one or more gases may be inserted into another gas, gases, or air or inserted into a flow of gas, gases, or air and so mixed during insertion that a homogeneous gas mixture results. Typically, the gas sparger will be a smaller diameter pipe within a pipe, which either through a series of small holes or a diffusion device will introduce a gas into a flow of another gas or air at right angles and in very small bubbles. Resulting turbulence of the combined gas flow tends to result in a homogeneous gas comprising both the sparged gas and the gas or air into which it was introduced.

15. Partial enclosure: A structure or device into which various openings for entrance and egress or ventilation are cut. Preferred embodiments would be a truck trailer which even with the loading doors closed has an air vent; various warehouses which even with all doors and windows closed have heating and cooling intakes and exhausts; and a city sewer system which has various grates, drains, and even vent holes in manhole covers.

16. Vaporizer: A device by which sufficient thermal energy may be imparted to a stream of a cryogenic liquid such as liquefied carbon dioxide so that the stream of liquid will be converted to a gas. These devices are commonly large water baths into which long coils of copper piping are immersed. The copper is used for carbon dioxide vaporization because of its ability to withstand the relatively high internal working pressures generated by vaporization of liquid carbon dioxide. The water in the bath is normally continuously refreshed to maintain the desirable thermodynamics of the vaporization.

### Description of Preferred Embodiments of the Invention

A. Method and System for Extermination of Rodentia in Mobile at Least Partial Enclosures Such as Food Transport Trailers and Ships Holds

### Structural Description

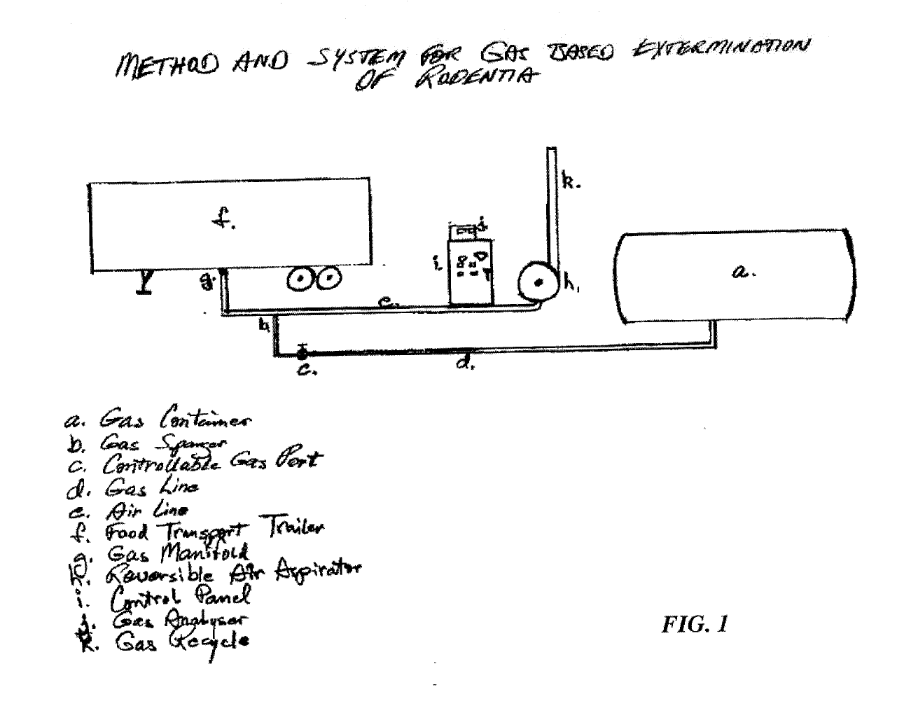

The major components of the invention when used for extermination of rodentia in food transport trailers is shown in FIG. 1. Preferably, a ready source of carbon dioxide is necessary and this is held in the gas container “a.” Gas container “a” or carbon dioxide generator “a.1” communicates with the gas sparger “b” and the controllable gas port “c” through gas line “d.” Gas sparger “b” communicates with air line “e” which communicates with the food transport trailer “f ” through the gas manifold “g” and the reversible air aspirator “h.” The reversible air aspirator “h” communicates with the gas recycler “k.” The control panel “i” is electrically coupled to the carbon dioxide gas analyzer “j,” to the controllable gas port “c,” and to the reversible air aspirator “h.” A further electrical connection is to the gas manifold “g” for a safety circuit. The gas analyzer “j” communicates with two carbon dioxide sensing probes. One is mounted between the gas sparger “b” and the gas manifold communicating the air line “e” to the food transport trailer “f.” The second is mounted between the gas sparger “b” and the air aspirator “h.”

### Functional Description

When a mobile partial enclosure such as a food transport trailer is to be exterminated for rodentia, a preferred embodiment of the process would be to position the food trailer adjacent to the equipment described in the structural description. Since this is an ongoing process the equipment is preferably installed in a permanent installation although it may be mounted on transport for mobile service. The gas manifold “g” is attached to its matching coupling on the trailer frame and the trailer vent is opened. The operator then activates the preprogrammed process. The air aspirator “h” is activated to force ambient air or recycled gas as available into the food trailer “f” and the controllable gas port “c” is opened automatically. The gas analyzer “j” senses the concentration of carbon dioxide in the air flow reaching the food trailer “f” and electrically adjusts the controllable gas port “c” for a preset concentration, preferably and substantially 65% CO2. A timer in the control panel “i” allows a preset volume of the air and CO2 mixture to flow into the food trailer “f.” When the preset volume is reached, the control panel shuts off the controllable gas port “c” and the air aspirator “h” for a preset time. This time is preferably 30 seconds but will vary according to food trailer contents and filled volume. This time is set to exceed the time required to exterminate the last rodent from the food trailer “f.” The extermination will be substantially by asphyxiation but also may be due to driving out.

The control panel will then turn on the reversible air aspirator “h” in the opposite direction or to evacuate the food trailer “f” of the air and CO2 mixture just aspirated into it. This cycle is run until the gas analyzer “j” senses that there is less than 0.5% of CO2 in the aspirating air flow. Should the cycle run for a preset time, preferably 180 seconds, and the CO2 remain above 0.3%, then an alarm will sound for the operator to take further remedial action before any person enters the food trailer “f.”

### Block Diagram

### See Attached FIG. 1

B. Method and System for Extermination of Rodentia in Partially Enclosed Facilities Such as Food Warehouses

### Structural Description

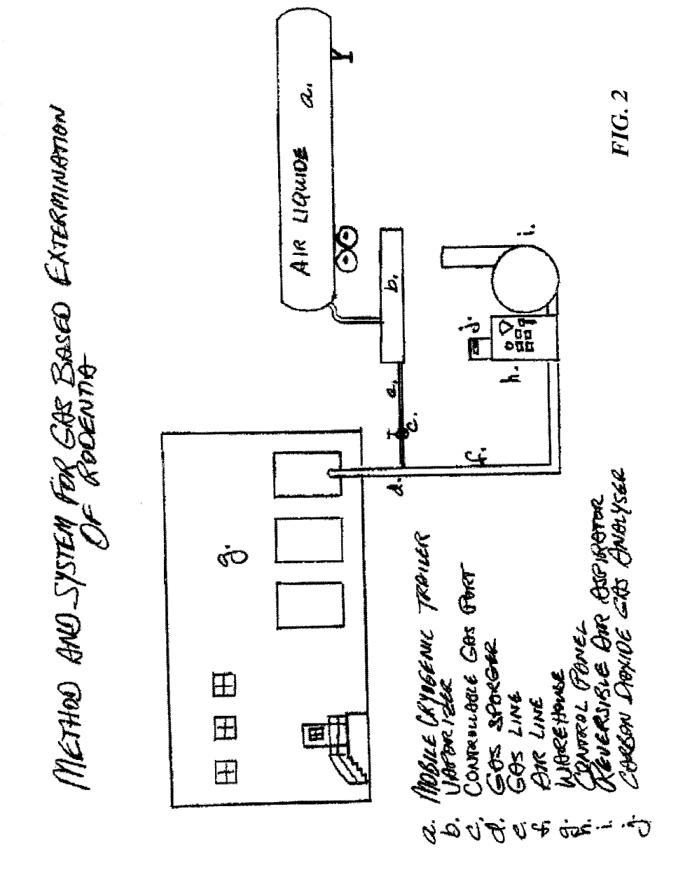

The major components of the invention when used for extermination of rodentia in food storage facilities such as grocery warehouses and grain mills are shown in FIG. 2. The source of carbon dioxide is preferably from mobile cryogenic transport trailers “a” although sourcing from permanently installed gas containers is also acceptable. The mobile cryogenic trailer(s) “a” communicate with a vaporizer “b” which aids the phase change of the carbon dioxide from liquid to gaseous state. The vaporizer “b” communicates with the controllable gas port “c” and the gas sparger “d” through gas line “e.” The gas sparger “d” communicates with air line “f,” the warehouse “g,” and the reversible air aspirator “i.” The carbon dioxide gas analyzer “j,” the controllable gas port “c,” and the reversible air aspirator “i” may be manually controlled or controlled through an automatic control panel “h.” The gas analyzer “j” is communicates with two carbon dioxide sensing probes. One is mounted between the gas sparger “d” and the warehouse “g” and the second is mounted between the gas sparger “d” and the air aspirator “i.”

### Functional Description

A preferred embodiment of this invention is to exterminate partially enclosed facilities such as food warehouses for rodentia. The warehouse “g” is prepped for the extermination by closing and temporarily sealing most doors and windows but leaving an opening for aspiration of air and a vent at some remote location from the aspiration site. The air line “f” is attached to the aspiration opening and the air aspirator “i” and the controllable gas port “c” are turned on either manually or electrically with the flow into the warehouse. The ambient air is changed by addition of a concentration of carbon dioxide, preferably 50%, either manually or electrically. The air aspirator “i” and the controllable gas port “c” are allowed to run for either a calculated amount of time or preferably until the ambient air concentration at the vent is substantially at least 50% carbon dioxide. This concentration of carbon dioxide within the partially enclosed structure will cause the extermination of rodentia within the structure, substantially by asphyxiation but also by driving out.

The controllable gas port “c” is then turned off and the air aspirator “i” is reversed to evacuate the substantially changed ambient air from the structure. The air aspirator will run until the carbon dioxide analyzer indicates that ambient levels of carbon dioxide have subsided to less than 0.3% at which time the structure will be safe for reentry.

### Block Diagram

### See FIG. 2

C. Method and System for Extermination of Rodentia in Partial Enclosures Such as Sewers and Subway Systems

### Structural Description

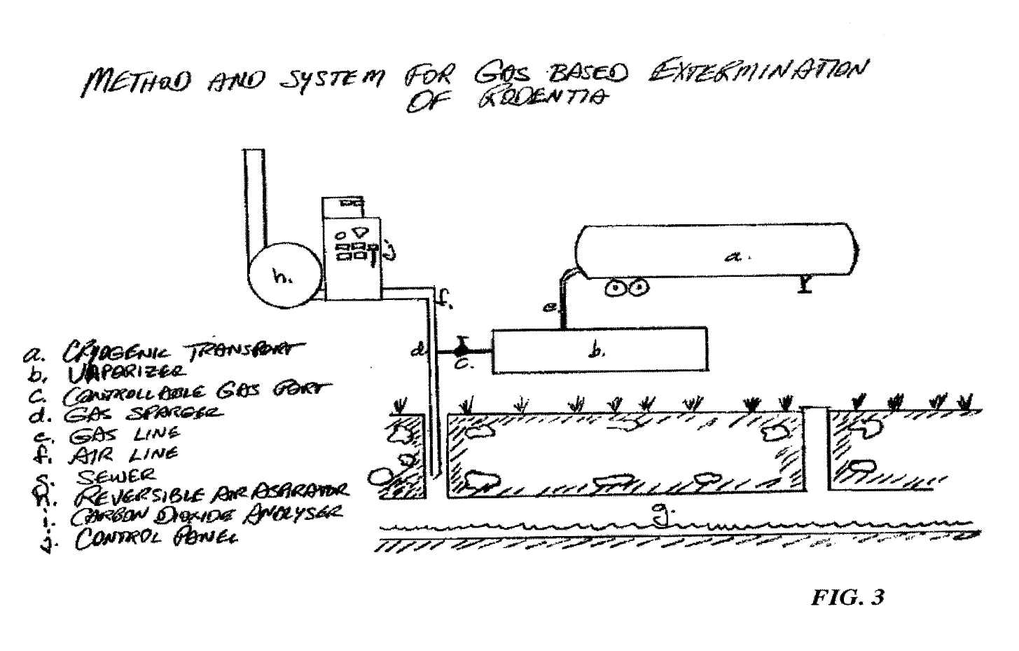

The major components of the invention when used for extermination of rodentia in at least partial enclosures such as sewers and subways are shown in FIG. 3. The source of carbon dioxide is once again preferably from mobile cryogenic transport trailers “a” although it is also perfectly acceptable to source from permanent gas storage vessels. In the preferred embodiment, the transport trailers “a” communicate with the vaporizer “b,” with the controllable gas port “c,” and the gas sparger “d” through gas line “e.” The gas sparger communicates with air line “f,” the sewer or subway “g,” and the reversible air aspirator “h.” The carbon dioxide gas analyzer “l,” the controllable gas port “c,” and the reversible air aspirator “h” may be controlled manually or through an automatic control panel “j.” The carbon dioxide gas analyzer “i” communicates with two carbon dioxide sensing probes. One is mounted between the gas sparger “d” and the sewer or subway “g” and the second is mounted between the gas sparger “d” and the reversible air aspirator “h.”

### Functional Description

A preferred embodiment of this invention is to exterminate rodentia in at least partially enclosed public facilities such as sewers or subways. Prior to commencement of the extermination effort, the sewer or subway will be as nearly sealed as possible with temporary gas barriers such as plastic sheeting and taped joints. However, designated vents will remain open where the escaping carbon dioxide will pose no risk to health and safety. An evaluation will have been made as to the number and location of injection sites. The following action steps will be followed at all such injection sites concurrently. The air line “f” will be directed into the sewer or subway and the reversible air aspirator “h” and the controllable gas port “c” are turned on simultaneously with the flow into the sewer or subway. The change of ambient air communicating through the air line “f” by introduction of carbon dioxide to a preferred concentration of substantially at least 50% may be controlled manually or electrically. The reversible air aspirator and the controllable gas port are allowed to run for the amount of time calculated to have exposed all areas of the at least partial enclosure or until the carbon dioxide readings at the vents indicate that the ambient air changed with preferentially 50% carbon dioxide has reached from the insertion site to the vent.

At this time the controllable gas port “c” is turned off and the reversible air aspirator “h” is reversed to evacuate the public work. The air aspirator is allowed to run until such time as the carbon dioxide gas analyzer indicates a reading of less than 0.3% carbon dioxide in the evacuating ambient air. Then safety personnel will enter the treated areas to assure that all pockets of carbon dioxide have been removed and it is safe to resume normal human activity within the public work.

### Block Diagram

### See FIG. 3

### Some Alternative Exemplary Embodiments of the Present Invention

I. A service by which mobile at least partial enclosures are exterminated for rodentia on a toll basis.

II. A system for exterminating rodentia from at least partial enclosures consisting of the components of gas container, gas sparger, controllable gas port, air aspirator, carbon dioxide gas analyzer, control panel, and communicating gas and air lines.

III. Any of the above components of a system for exterminating rodentia.

While there has been illustrated and described what are presently considered to be the preferred embodiments of the present invention, it will be understood by those of ordinary skill in the art that various other modifications may be made, and equivalents may be substituted, without departing from the true scope of the present invention.

Additionally, many modifications may be made to adapt a particular situation to the teachings of the present invention without departing from the central inventive concept described herein. Furthermore, an embodiment of the present invention may not include all of the features described above.

Therefore, it is intended that the present invention not be limited to the particular embodiments disclosed, but that the invention include all embodiments falling within the scope of the appended claims.

What is claimed is:

1. A method for exterminating at least one rodent in an at least partial enclosure, the method comprising the steps of:
introducing gas comprising carbon dioxide gas into an at least partial enclosure at least partially containing an ambient atmosphere; and
changing, by introducing the gas, the concentration of carbon dioxide in the ambient atmosphere sufficient to exterminate at least one rodent that respirates the ambient atmosphere.

2. The method of claim 1, further comprising the step of restoring the ambient atmosphere to substantially an air atmosphere that is safe for human respiration.

3. The method of claim 2, wherein the restoring step comprises the step of at least partially evacuating the ambient atmosphere from the at least partial enclosure.

4. The method of claim 2, wherein the restoring step comprises the step of introducing air into the at least partial enclosure.

5. The method of claim 2, wherein the restoring step comprises the steps of
aspirating gas from the ambient atmosphere; and
introducing air into the at least partial enclosure.

6. The method of claim 1, wherein the changing step comprises the step of killing at least one rodent that respirates the ambient atmosphere.

7. The method of claim 1, wherein the changing step comprises the step of asphyxiating at least one rodent that respirates the ambient atmosphere.

8. The method of claim 1, wherein the changing step comprises the step of driving out of the at least partial enclosure the at least one rodent that respirates the ambient atmosphere.

9. The method of claim 1, further comprising the step of measuring a carbon dioxide concentration of the ambient atmosphere.

10. The method of claim 1, wherein the changing step comprises the step of changing the ambient atmosphere to a concentration of carbon dioxide that is substantially at least 20% of the at least partially contained ambient atmosphere.

11. The method of claim 1, wherein the changing step comprises the step of changing the ambient atmosphere to a concentration of carbon dioxide that is substantially 50% of the at least partially contained ambient atmosphere.

12. A gas based rodentia extermination system comprising:
a controllable gas port for mechanically coupling to an at least partial enclosure at least partially containing an ambient atmosphere for selectively communicating gas with the ambient atmosphere;
a gas line mechanically coupled to controllable gas port for providing gas communication with the ambient atmosphere; and
a gas container containing a gas comprising a concentration of carbon dioxide, the gas container being mechanically coupled to the gas line and to the controllable gas port, for selectively providing the gas to the at least partial enclosure to change a concentration of carbon dioxide in the ambient atmosphere sufficient to exterminate at least one rodent that respirates the ambient atmosphere.

13. The system of claim 12, further comprising:
a gas sparger mechanically coupled to the gas line and to the controllable gas port to control a concentration of carbon dioxide in the gas being provided to the at least partial enclosure.

14. The system of claim 12, further comprising:
a gas analyzer mechanically coupled to the controllable gas port for indicating a concentration of carbon dioxide in the ambient atmosphere.

15. The system of claim 14, further comprising:
a controller, electrically coupled to the gas analyzer and to the controllable gas port, for controlling the controllable gas port to provide the gas to the at least partial enclosure with a carbon dioxide concentration to change a concentration of carbon dioxide measured by the gas analyzer in the ambient atmosphere to substantially a predefined concentration value to exterminate at least one rodent that respirates the ambient atmosphere.

16. The system of claim 15, wherein the predefined concentration value corresponds to substantially at least 20% carbon dioxide concentration in the at least partially contained ambient atmosphere.

17. The system of claim 15, wherein the predefined concentration value corresponds to substantially 50% carbon dioxide concentration in the at least partially contained ambient atmosphere.

18. The system of claim 15, wherein the at least partial enclosure comprises at least one of a transport trailer, a truck cargo hold, a building, a ship cargo hold, at least a portion of a sewer line, and at least a portion of a tunnel.

19. A method for exterminating at least one rodent, the method comprising the step of:
suddenly confronting at least one rodent with an ambient atmosphere that includes a concentration of carbon dioxide that, after the at least one rodent's exposure to the ambient atmosphere, will have the effect of severely limiting the at least one rodent's further travel, will preclude further voiding of the at least one rodent's bowels, and will result in the at least one rodent's immobilization and subsequent extermination in less than 60 seconds from the first exposure to the ambient atmosphere.

20. A method for exterminating at least one rodent in an at least partial enclosure by confronting the at least one rodent with an ambient atmosphere including a concentration of carbon dioxide, and wherein the ambient atmosphere includes no carcinogens and wherein no toxic residue remains after the extermination of the at least one rodent.

21. A method for exterminating at least one rodent in an at least partial enclosure by confronting the at least one rodent with an ambient atmosphere including a concentration of carbon dioxide, and wherein there is substantially no release of contaminating blood from the at least one rodent while expiring.
